(19) United States
(12) Patent Application Publication
(10) Pub. No.: US 2016/0205383 A1
(43) Pub. Date: Jul. 14, 2016

(54) MULTIVIEW IMAGE DISPLAY DEVICE

(71) Applicant: SAMSUNG DISPLAY CO., LTD., YONGIN-SI (KR)

(72) Inventors: GORO HAMAGISHI, HWASEONG-SI (KR); SE HUHN HUR, YONGIN-SI (KR); IL-JOO KIM, HWASEONG-SI (KR); KYUNG HO JUNG, SEONGNAM-SI (KR)

(21) Appl. No.: 14/861,491

(22) Filed: Sep. 22, 2015

(30) Foreign Application Priority Data
Jan. 13, 2015 (KR) 10-2015-0006148

(51) Int. Cl. H04N 13/02

(52) U.S. Cl. CPC H04N 13/0282; H04N 13/0257; H04N 13/0296; H04N 13/0228

(57) ABSTRACT

A multi-view image display device includes a display panel that includes a plurality of pixels arranged in a matrix form, and a viewpoint divider for dividing an image received from the display panel into images corresponding to k viewpoints, wherein the viewpoint divider includes a plurality of viewpoint division units that are tilted with respect to a column direction of the pixels at a tilt angle that satisfies

$$VA = {tan}^{- 1} \frac{b \times Hp}{n \times Vp} , \\ n \neq b , \\ b \neq 1 ,$$

where Hp denotes a pixel pitch in a row direction of the pixels, Vp denotes a pixel pitch in the column direction, b and n are natural numbers and b/n corresponds to an irreducible fraction, wherein a plurality of first pixels that emit light that propagates through a same viewpoint division unit to substantially a same position at a predetermined distance from the viewpoint divider are arranged in a unit pixel area defined on an n×2n-dot basis of the display panel.

### CROSS-REFERENCE TO RELATED APPLICATION

This application claims priority under 35 U.S.C. §119 from Korean Patent Application No. 10-2015-0006148 filed in the Korean Intellectual Property Office on Jan. 13, 2015, and all the benefits accruing therefrom, the contents of which are herein incorporated by reference in their entirety.

### BACKGROUND

(a) Technical Field

Embodiments of the present disclosure are directed to a multi-view image display device, and more particularly, to an autostereoscopic multi-view image display device.

(b) Discussion of the Related Art

With development of display device technology, research multi-view image display devices and three-dimensional (3D) stereoscopic image display devices have been studied.

In general, in a multi-view image display device, different viewing zones are formed with respect to different viewing angles of the multi-view image display device. A multi-view image display device displays an image so that observers positioned at different viewing zones perceive different images.

A multi-view image display device can function as a 3D stereoscopic image display device by using binocular parallax through which different images are perceived in different viewing zones, so that a viewer may perceive an object in 3D.

A 3D stereoscopic image display device displays an image so that different two-dimensional (2D) images are observed in a viewing zone of a left eye of an observer and a viewing zone of a right eye of the observer. Then, when the image viewed by the left eye, hereinafter referred to as a left eye image, and the image viewed by the right eye, hereinafter referred to as a right eye image, are transmitted to the brain of the observer, the left eye image and the right eye image are perceived as a 3D stereoscopic image.

Examples of a multi-view image display device or a 3D stereoscopic image display device include a stereoscopic display device that uses glasses, such as shutter glasses, polarized glasses, etc., and an autostereoscopic display device that includes an optical system, such as a lenticular lens, a parallax barrier, etc., disposed therein, eliminating the need for glasses.

An autostereoscopic scheme implements a multi-view image or a stereoscopic image by dividing a stereoscopic image into images that correspond to several viewpoints and displaying the divided images using a lenticular lens, a parallax barrier which has a plurality of openings, etc.

### SUMMARY

Embodiments of the present disclosure can provide a multi-view image display device that optimizes resolution of a stereoscopic image perceived at each viewpoint in an autostereoscopic multi-view image display device.

Further, embodiments of the present disclosure can provide a multi-view image display device that may prevent generation of crosstalk in a autostereoscopic multi-view image display device.

An exemplary embodiment provides a multi-view image display device including a display panel that includes a plurality of pixels arranged in a matrix form, and a viewpoint divider for dividing an image received from the display panel into images corresponding to k viewpoints, wherein the viewpoint divider includes a plurality of viewpoint division units that are tilted with respect to a column direction of the pixels at a tilt angle VA that satisfies the following equation:

$$VA = {tan}^{- 1} \frac{b \times Hp}{n \times Vp} , \\ n \neq b , \\ b \neq 1 ,$$

where Hp denotes a pixel pitch in a row direction of the pixels, Vp denotes a pixel pitch in the column direction, b and n are natural numbers and b/n corresponds to an irreducible fraction, wherein a plurality of first pixels that emit light that propagates through a same viewpoint division unit to substantially a same position at a predetermined distance from the viewpoint divider are arranged in a unit pixel area defined on an n×2n-dot basis of the display panel.

The plurality of first pixels included in the unit pixel area may display different primary colors.

A plurality of first pixels included in unit pixel areas corresponding to three viewpoint division units may include two sets of red (R) pixels, green (G) pixels and blue (B) pixels.

A pitch of each viewpoint division unit corresponds to 2n pixels.

A plurality of pixels included in three unit pixel areas may include R pixels, G pixels and B pixels corresponding to n² viewpoints.

n may equal 4, and b may equal 3.

n may equal 4, and b may equal 5.

The viewpoint division units may include lenticular lenses.

Pixels on adjacent pixel columns may display different primary colors.

Another exemplary embodiment provides a multi-view image display device including a display panel that includes a plurality of pixels arranged in a matrix form, and a viewpoint divider for dividing an image received from the display panel into images corresponding to k viewpoints, wherein the viewpoint divider includes a plurality of viewpoint division units that are tilted with respect to a column direction of the pixels at a tilt angle VA that satisfies the following equation:

$$VA = {tan}^{- 1} \frac{Hp}{k \times Vp} ,$$

where Hp denotes a pixel pitch in a row direction of the pixels, Vp denotes a pixel pitch in the column direction, and k is a natural number, wherein a plurality of first pixels that emit light that propagates to a same viewpoint division unit to substantially a same position at a predetermined distance from the viewpoint divider are arranged in a unit pixel area defined on a 2k×k-dot basis of the display panel.

The plurality of first pixels included in the unit pixel area may display different primary colors.

A plurality of first pixels included in unit pixel areas corresponding to three viewpoint division units include two sets of red (R) pixels, green (G) pixels and blue (B) pixels.

A pitch of each viewpoint division unit may correspond to 4k pixels.

A plurality of pixels included in three unit pixel areas may include R pixels, G pixels and B pixels corresponding to 4k² viewpoints.

Another exemplary embodiment provides a multi-view image display device including a display panel that includes a plurality of pixels arranged in a matrix form; and a viewpoint divider configured to divide an image received from the display panel into images that correspond to k viewpoints, wherein the viewpoint divider includes a plurality of viewpoint division units that are tilted with respect to a column direction of the pixels at a tilt angle VA, a plurality of first pixels that emit light that propagates through a same viewpoint division unit to substantially a same position at a predetermined distance from the viewpoint divider are arranged in a unit pixel area defined on the display panel, the plurality of first pixels included in the unit pixel area display different primary colors, and a plurality of first pixels included in unit pixel areas corresponding to three viewpoint division units include two sets of red (R) pixels, green (G) pixels and blue (B) pixels.

The unit pixel area may be defined on an n×2n-dot basis the display panel, and the tilt angle VA may satisfy the following equation:

$$VA = {tan}^{- 1} \frac{b \times Hp}{n \times Vp} , \\ n \neq b , \\ b \neq 1 ,$$

wherein Hp denotes a pixel pitch in a row direction of the pixels, Vp denotes a pixel pitch in the column direction, b and n are natural numbers and b/n corresponds to an irreducible fraction.

A pitch of each viewpoint division unit may correspond to 2n pixels, and a plurality of pixels included in three unit pixel areas may include R pixels, G pixels and B pixels corresponding to n² viewpoints.

The unit pixel area may be defined on an 2k×k-dot basis the display panel, and the tilt angle VA may satisfy the following equation:

$$VA = {tan}^{- 1} \frac{Hp}{k \times Vp} ,$$

wherein Hp denotes a pixel pitch in a row direction of the pixels, Vp denotes a pixel pitch in the column direction, and k is a natural number.

A pitch of each viewpoint division unit may correspond to 4k pixels, and a plurality of pixels included in three unit pixel areas may include R pixels, G pixels and B pixels corresponding to 4k² viewpoints.

The viewpoint division units may include lenticular lenses.

According to exemplary embodiments of the present disclosure, resolution of a stereoscopic image displayed in an autostereoscopic multi-view image display device may be optimized.

According to exemplary embodiments of the present disclosure, crosstalk generated in an autostereoscopic multi-view image display device may be suppressed.

### BRIEF DESCRIPTION OF THE DRAWINGS

FIG. 1 is a schematic perspective view of a multi-view image display device according to an exemplary embodiment.

FIG. 2 illustrates pixels that emit light that propagates through a viewing zone of a multi-view image display device according to an exemplary embodiment.

FIG. 3 illustrates viewing zones through which light emitted from a pixel of a multi-view image display device according to an exemplary embodiment propagates.

FIG. 4 illustrates an arrangement of lenticular lenses and a display panel of a multi-view image display device according to an embodiment.

FIG. 5 schematically illustrates crosstalk in a multi-view image display device according to an exemplary embodiment.

FIG. 6 is a graph of crosstalk observed at the OVD of a multi-view image display device according to an exemplary embodiment.

FIG. 7 illustrates an arrangement of lenticular lenses and a display panel of a multi-view image display device according to other exemplary embodiments.

FIG. 8 schematically illustrates crosstalk of a multi-view image display device according to other exemplary embodiments.

FIG. 9 illustrates an arrangement of lenticular lenses and a display panel of a multi-view image display device according to still other embodiments.

FIG. 10 schematically illustrates crosstalk of a multi-view image display device according to other exemplary embodiments.

FIG. 11 is a graph of crosstalk observed at an OVD of a multi-view image display device according to other exemplary embodiments.

### DETAILED DESCRIPTION OF THE EMBODIMENTS

Hereinafter, exemplary embodiments will be described in detail with reference to the accompanying drawings. The same or similar reference numerals may be used to refer to the same or a similar component, and repeated description thereof will be omitted.

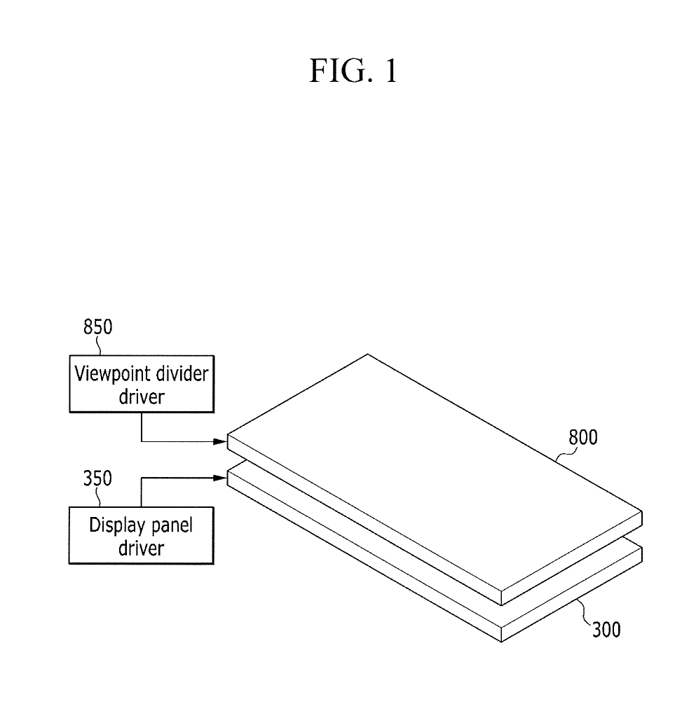

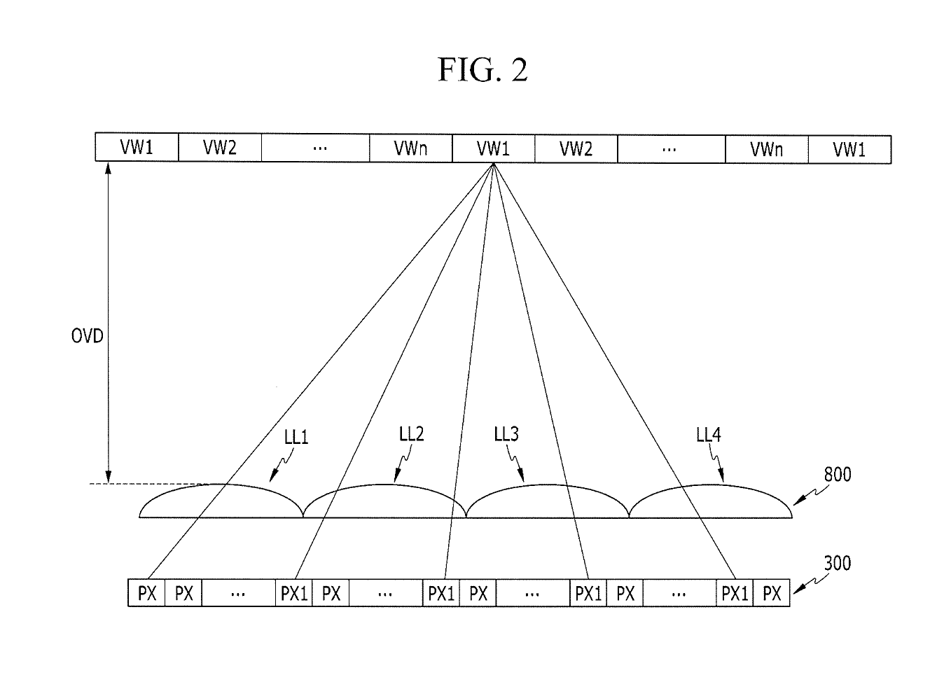

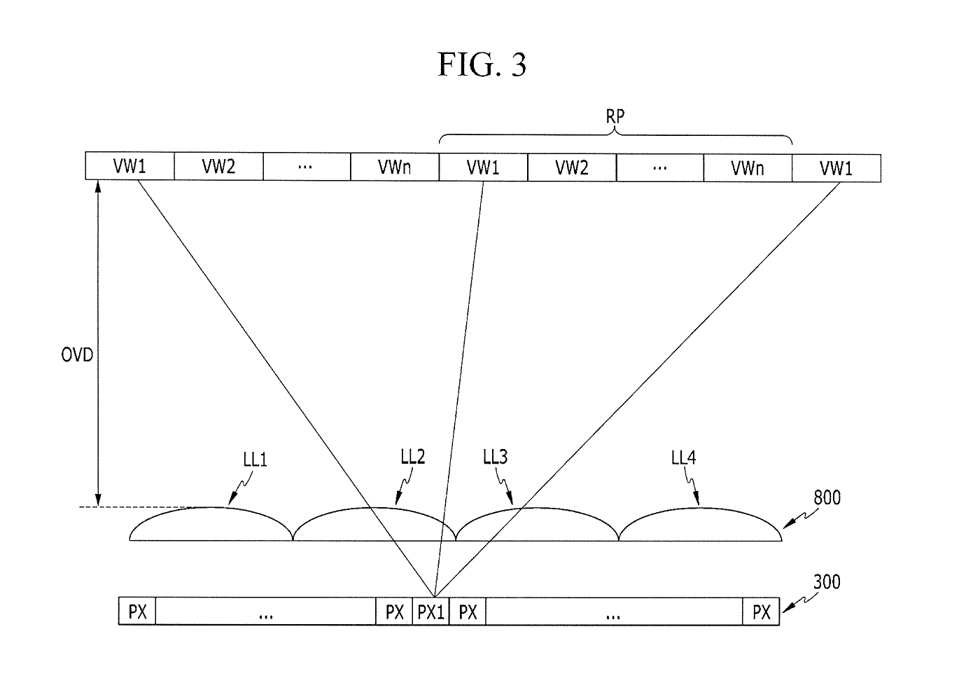

When a component is mentioned as being “connected” to or “accessing” another component, this may mean that it is directly connected to or accessing the other component, but it is to be understood that another component may exist therebetween. FIG. 1 is a schematic perspective view of a multi-view image display device according to an exemplary embodiment, FIG. 2 illustrates pixels that emit light that propagates through a viewing zone of a multi-view image display device according to an exemplary embodiment, and FIG. 3 illustrates viewing zones through which light emitted from a pixel of a multi-view image display device according to a exemplary embodiment propagates.

Referring to FIGS. 1 to 3, a multi-view image display device according to an exemplary embodiment includes a display panel 300, a display panel driver 350, a viewpoint divider 800, and a viewpoint divider driver 850.

The display panel 300 displays an image, and may be one of a plasma display panel (PDP), a liquid crystal display, or an organic light-emitting device.

The display panel 300 includes a plurality of signal lines and a plurality of pixels connected thereto. The plurality of pixels may be substantially arranged in a matrix form.

Each of the pixels may include a switching element, such as a thin film transistor, connected to a corresponding signal line, and a pixel electrode connected thereto. The signal lines may include a plurality of gate lines, each of which transmits a gate signal, also referred to as a scanning signal or a scan signal, corresponding to each pixel, and a plurality of data lines, each of which transmits a data signal corresponding to each pixel.

When a pixel uniquely displays one of primary colors in a spatial division mode, or a plurality of pixels alternately display primary colors over time in a temporal division mode, a spatial sum or a temporal sum of the primary colors may be displayed as a desired color on the display panel 300. Various combinations of three colors or four colors may be used as the primary colors. However, for purposes of explanation, a present exemplary embodiment will be described in terms of three primary colors of red (R), green (G), and blue (B).

A set of pixels displaying different primary colors may form one dot, and the one dot may be a display unit of a stereoscopic image. Alternatively, one pixel may be referred to as one dot. Hereinafter, one dot refers to one pixel unless a particular restriction is imposed.

Pixels of one pixel column may display the same primary color. However, embodiments of the present disclosure are not limited thereto, and pixels diagonally arranged at a certain angle may display the same primary color.

The display panel driver 350 transmits various driving signals, such as a gate signal and a data signal, to the display panel 300 to drive the display panel 300.

The viewpoint divider 800 can divide an image received from the display panel 300 into images that correspond to k viewpoints, where k is a natural number. The viewpoint divider 800 transmits, refracts, reflects or divides light from a pixel of the display panel 300.

Referring to FIGS. 2 and 3, the viewpoint divider 800 according to an exemplary embodiment may include a plurality of viewpoint division units LL1, LL2, LL3 and LL4. Hereinafter, the viewpoint divider 800 according to an exemplary embodiment is assumed to be a plurality of lenticular lenses. A technology applied to the plurality of lenticular lenses may also be applied to a viewpoint divider 800 that includes a parallax barrier, which includes an opening and a light-shielding unit.

Hereinafter, viewpoint divider 800 will be described on the assumption that the plurality of respective viewpoint division units LL1, LL2, LL3 and LL4 are lenticular lenses arranged in one direction.

Each of the lenticular lenses LL1, LL2, LL3 and LL4 may extend in one direction. Each of the lenticular lenses LL1, LL2, LL3 and LL4 may extend in a direction that forms an acute angle with a column direction of the pixels, or may be parallel with the column direction.

Let a distance between the multi-view image display device and a place where an optimal stereoscopic image may be observed be referred to as an optimal viewing distance (OVD). Then, a position of a place through which light emitted from each pixel PX and PX1 and propagating through each lenticular lens at the OVD is received may be referred to as a viewpoint.

Each of the lenticular lenses LL1, LL2, LL3 and LL4 divides light of each of the pixels PX and PX1 so that the divided light propagates to a plurality of corresponding viewpoints VW1 to VWn, where n is a natural number.

According to an exemplary embodiment, each pixel PX and PX1 of the display panel 300 corresponds to one of the plurality of viewpoints VW1 to VWn, and light emitted from each pixel PX and PX1 passes the viewpoint divider 800 and propagates to the corresponding viewpoint VW1 to VWn.

FIG. 2 illustrates an example in which a finite number of viewpoints VW1 to VWn are positioned at the OVD.

As illustrated in FIG. 2, light from a plurality of first pixels PX1 on the display panel 300 may propagate through at least one corresponding lens of the plurality of lenticular lenses LL1, LL2, LL3 and LL4, and propagate through a first viewpoint VW1 at the OVD.

When an observer's eye is positioned at the first viewpoint VW1, the observer may generally receive light from the first pixels PX1, and perceived an image from the received light.

Referring to FIG. 3, light from each of the pixels PX and PX1 may propagate to one of viewpoints VW1 to VWn in a unit view area RP through the viewpoint divider 800.

For example, light from one of the first pixels PX1 may pass through at least one lenticular lens LL2 and LL3, and propagate to a plurality of first viewpoints VW1s present at the OVD.

Each of the viewpoints VW1 to VWn is positioned in one of the RPs. In addition, the RPs may be periodically repeated at the OVD, and viewpoints VW1 to VWn in each of the RPs may be positioned in a certain order.

FIGS. 1 to 3 illustrate one viewpoint divider 800 positioned between the display panel 300 and the observer. However, embodiments of the present disclosure are not limited thereto. The viewpoint divider 800 may be positioned at the rear of the display panel 300, and a plurality of viewpoint dividers, each of which corresponds to the viewpoint divider 800, may be positioned between the display panel 300 and the observer.

The viewpoint divider driver 850 is connected to the viewpoint divider 800 to generate a driving signal for driving the viewpoint divider 800.

For example, when a multi-view image display device displays one image on the entire display panel 300, the viewpoint divider driver 850 may generate a driving signal to suspend operation of the viewpoint divider 800. In addition, when a multi-view image display device displays a multi-view image, the viewpoint divider driver 850 may generate a driving signal to start operation of the viewpoint divider 800.

Even though FIG. 1 illustrates an example in which the display panel driver 350 and the viewpoint divider driver 850 are separately provided, the display panel driver 350 and the viewpoint divider driver 850 may be provided as one integrated unit.

Through a multi-view image display device, an observer may perceive light received at the same viewpoint, such as VW1, as one image, and a plurality of images may be perceived at each of the viewpoints VW1 to VWn.

When a multi-view image display device operates as a stereoscopic image display device, an observer may perceived different images from light emitted from pixels corresponding to different viewpoints, such as VW1 for a left eye and VW4 for a right eye, using both respective eyes, thereby perceiving depth.

Hereinafter, a description will be given of exemplary embodiments directed to a multi-view image display device configured as described above with reference to drawings.

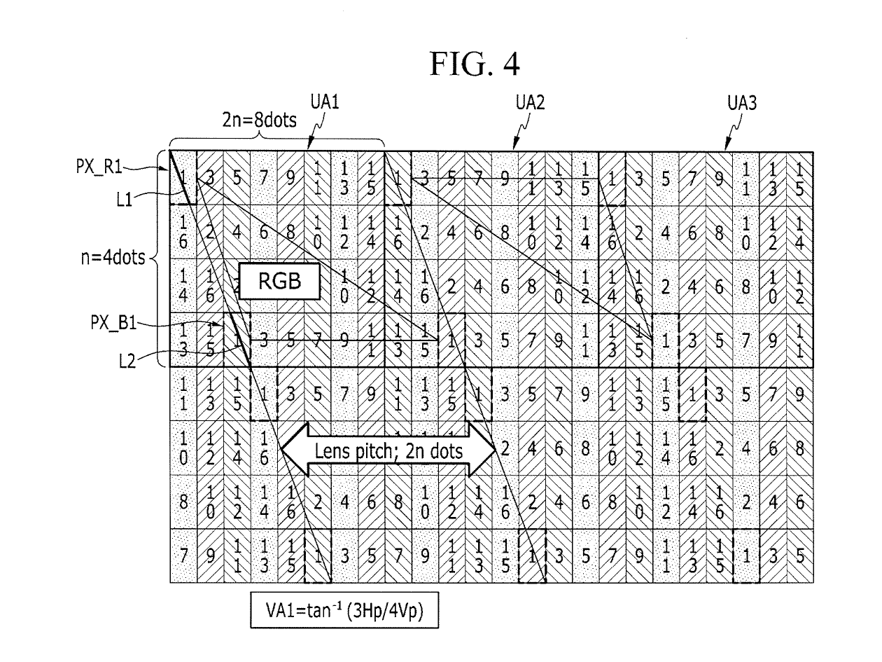

FIG. 4 illustrates an arrangement of the lenticular lenses 800 and the display panel 300 of a multi-view image display device according to an embodiment. As illustrated in the figure, a plurality of pixels emitting light that correspond to a plurality of viewpoints may be disposed in unit pixel areas UA1, UA2 and UA3 defined on an n×2n-dot basis.

For example, first viewpoint pixels that emit light corresponding to a first viewpoint, second viewpoint pixels that emit light corresponding to a second viewpoint, . . . , and sixteenth viewpoint pixels that emit light corresponding to a sixteenth viewpoint may be disposed in each of the unit pixel areas.

A plurality of viewpoint pixels that correspond to the first viewpoint pixels, the second viewpoint pixels, . . . , or the sixteenth viewpoint pixels may be disposed in each of the unit pixel areas. For example, the first viewpoint pixels disposed in the same unit pixel area may emit light having different primary colors. As illustrated in the figure, two first viewpoint pixels PX_R1 and PX_B1 may be disposed in the first unit pixel area UA1, and the two first viewpoint pixels PX_R1 and PX_B1 may emit light having different primary colors.

In addition, the first viewpoint pixels may be appropriately disposed corresponding to a tilt angle of the lenticular lenses so that light of the first viewpoint pixels propagate to the first viewpoint at the OVD through the lenticular lenses.

For example, the first viewpoint pixels PX_R1 and PX_B1 may be disposed so that a length L1 by which a red first viewpoint pixel PX_R1 overlaps a tilt angle line of the lenticular lenses is substantially equal to a length L2 by which a blue first viewpoint pixel PX_B1 overlaps the tilt angle line of the lenticular lenses in the first unit pixel area UA1.

The lenticular lenses may be disposed on the pixels at a tilt angle VA1 formed by the extension direction of the lenticular lenses with respect to the column direction. The tilt angle VA1 of the lenticular lenses according to an exemplary embodiment may be calculated using the following Equation 1.

$$VA = {tan}^{- 1} \frac{b \times Hp}{n \times Vp} , \\ n \neq b , b \neq 1 \\ \frac{b}{n} = irreducible fraction \qquad [ Equation 1 ]$$

Here, VA denotes the tilt angle of the extension direction of the lenticular lenses with respect to the column direction, Hp denotes a pixel pitch in a horizontal direction, Vp denotes a pixel pitch in a vertical direction, and b and n are natural numbers.

FIG. 4 illustrates an example of the lenticular lenses when n equals 4 and b equals 3. The tilt angle VA1 of the lenticular lenses illustrated in FIG. 4 is 20.56° when calculated based on Equation 1, assuming that Hp/Vp=½.

In addition, a width LP (lens pitch) of a lenticular lens may be determined from the following Equation 2.

LP=2n [Equation 2]

In this instance, a unit of LP may be a dot. A pitch of each of the lenticular lenses illustrated in FIG. 4 is 8 dots when calculated based on Equation 2, and the 8 dots correspond to the horizontal pitch Hp of eight pixels. A width of one lens may correspond to one unit pixel area.

Six first viewpoint pixels may be disposed in three unit pixel areas UA1, UA2 and UA3 contiguous in a row direction. Among the six first viewpoint pixels, two first viewpoint pixels are red pixels (R), two first viewpoint pixels are green pixels (G), and two first viewpoint pixels are blue pixels (B). In other words, the six first viewpoint pixels disposed in a region corresponding to a width of three lenticular lenses may form two sets of RGB pixels.

The width of the three lenses correspond to width of the three unit pixel areas UA1, UA2 and UA3, and the six first viewpoint pixels may form two sets of RGB pixels in the three unit pixel areas UA1, UA2 and UA3. Thus, a maximum number of viewpoints displayable by a multi-view image display device according to an exemplary embodiment may be calculated using the following Equation 3.

$$The Number of View Points = \frac{3 \times 2 n \times n}{2 \times 3} = {n}^{2} , \qquad [ Equation 3 ]$$

where the “3” in the numerator refers to three unit pixel areas UA1, UA2, and UA3, 2n×n is the area of one unit pixel area, and the “2” in the denominator refers to 2 sets of RGB (2×3) pixels, which equals to n².

In the example of FIG. 4, n equals 4, and thus the maximum number of viewpoints displayable by a multi-view image display device is 16 when calculated based on Equation 3.

A multi-view image display device may form two sets of RGB pixels corresponding to respective viewpoints in the unit pixel areas UA1, UA2 and UA3 corresponding to the width of the three lenses. In this instance, the RGB pixels may be disposed in a triangular shape, thereby enhancing a resolution of a displayed image.

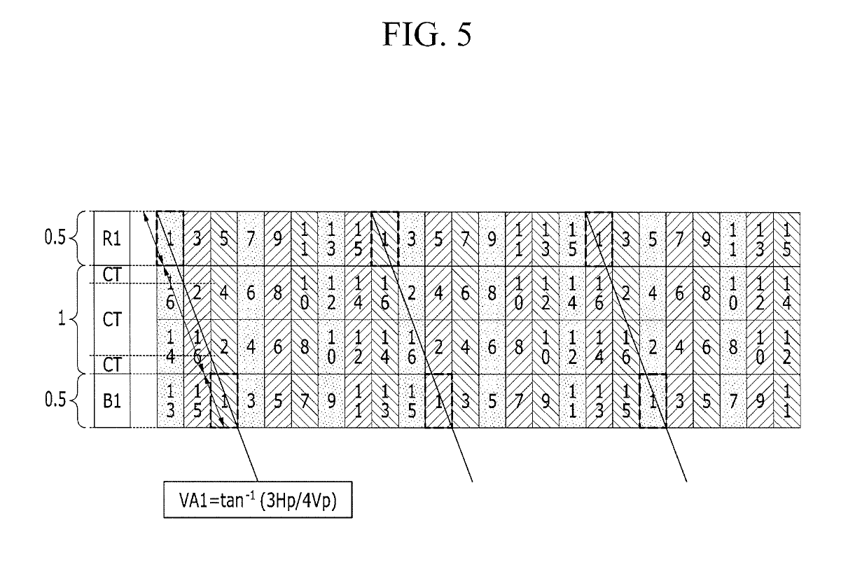

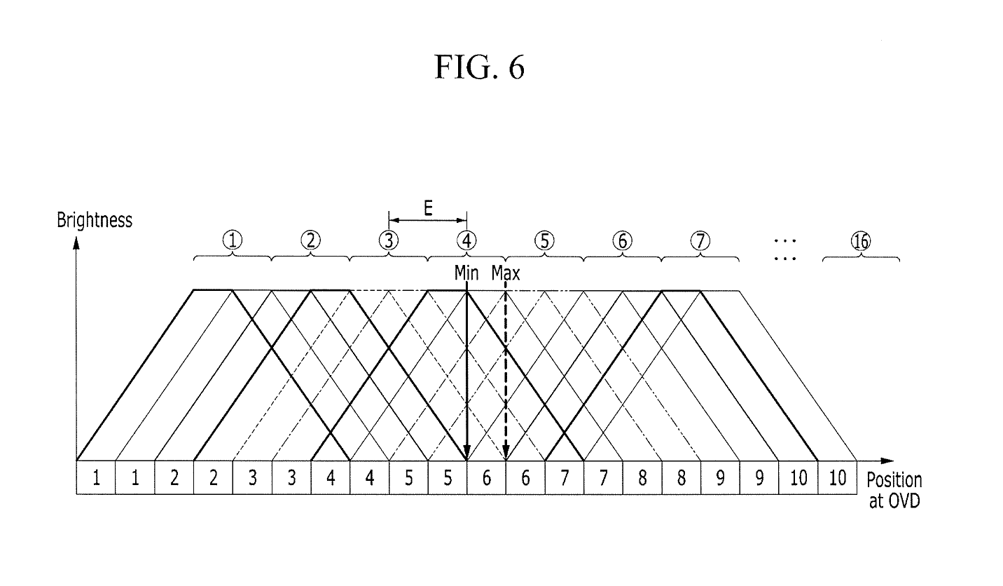

Next, a description will be given of crosstalk generated in a multi-view image display device according to an exemplary embodiment with reference to FIGS. 5 and 6.

FIG. 5 schematically illustrates crosstalk in a multi-view image display device according to an exemplary embodiment, and FIG. 6 is a graph of crosstalk observed at the OVD of a multi-view image display device according to an exemplary embodiment.

Light from pixels that overlap the same tilt angle line illustrated in FIG. 5 may propagate to the same viewpoint at the OVD. The tilt angle line overlaps a first viewpoint pixel 1, a second viewpoint pixel 2 and a sixteenth viewpoint pixel 16. Thus, light emitted from the first viewpoint pixel 1, the second viewpoint pixel 2 and the sixteenth viewpoint pixel 16 may propagate to a first viewpoint at the OVD.

Therefore, when an observer is positioned at the first viewpoint of the OVD, light from the second viewpoint pixel 2 and the sixteenth viewpoint pixel 16 may be received in addition to light from the first viewpoint pixel 1, and thus crosstalk may be generated. Crosstalk can be calculated as follows: In FIG. 5, when the inclination line overlaps pixels 1, 16, 2, 16, 2, and 1, the observer can see pixels 1, 16, 2, 16, 2, and 1. However, light from pixels 16, 2, 16, and 2 crosstalk to the observer, as may be seen in the left side of FIG. 5, which as crosstalk of 0.5 in R1, 1 in CT: 1, and 0.5 in B1. When crosstalk is generated, an observer may view an abnormal image.

Referring to a ratio of generated crosstalk based on the tilt angle line in FIG. 5, when light emitted from the first viewpoint pixel 1 has a ratio of 1, light from the second viewpoint pixel 2 and the sixteenth viewpoint pixel 16 has a ratio of 1, and thus crosstalk is generated at a ratio of 100%.

Referring to FIG. 6, in this regard, light from pixels disposed on the display panel 300 propagate through the lenticular lenses 800, and light may be received at positions \textcircled{1} to \textcircled{16} that respectively correspond to the first to sixteenth viewpoints at the OVD. In this instance, it may be assumed that a width at each position corresponds to a distance E between two eyes of the observer.

Referring to position \textcircled{4} corresponding to a fourth viewpoint, when maximum crosstalk (Max) is generated, a ratio of light of a fourth viewpoint pixel 4 is 1+0.66, a ratio of light of a fifth viewpoint pixel 5 is 1+0.66, and a ratio of light of a sixth viewpoint pixel 6 is 0.33+0.33, and thus crosstalk may be generated at a ratio of 2.33/1.66=140%.

On the other hand, when minimum crosstalk (Min) is generated, the ratio of light of the fourth viewpoint pixel 4 is 1+1, the ratio of light of the fifth viewpoint pixel 5 is 0.66+0.33, and the ratio of light of the sixth viewpoint pixel 6 is 0.66+0.33, and thus crosstalk may be generated at a ratio of 2/2=100%.

As described with reference to FIGS. 5 and 6, a multi-view image display device according to a present embodiment is effective in suppressing crosstalk since crosstalk is generated at a ratio ranging from 100% to 140%.

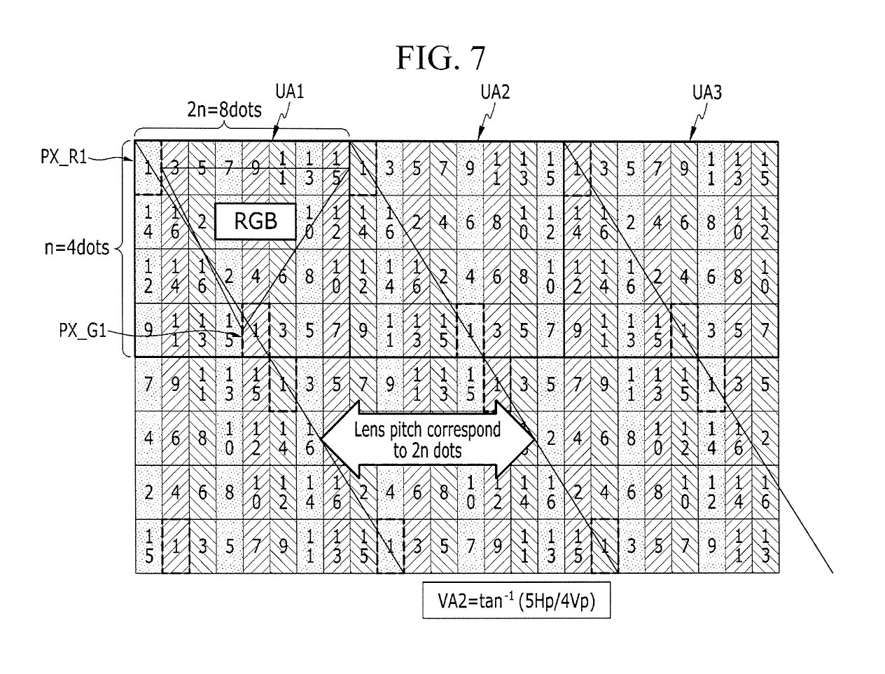

Next, referring to FIG. 7, a description will be given of a multi-view image display device according to other exemplary embodiments.

FIG. 7 illustrates an arrangement of lenticular lenses 800 and a display panel 300 of a multi-view image display device according to other embodiments. As illustrated in the figure, a plurality of pixels that emit light corresponding to a plurality of viewpoints may be disposed in each of unit pixel areas UA1, UA2 and UA3 formed on an n×2n-dot basis.

For example, first viewpoint pixels that emit light corresponding to a first viewpoint, second viewpoint pixels that emit light corresponding to a second viewpoint, . . . , and sixteenth viewpoint pixels that emit light corresponding to a sixteenth viewpoint may be disposed in each of the unit pixel areas.

A plurality of viewpoint pixels that correspond to the first viewpoint pixels, the second viewpoint pixels, . . . , or the sixteenth viewpoint pixels may be disposed in each of the unit pixel areas. For example, the first viewpoint pixels disposed in the same unit pixel area may emit light having different primary colors. As illustrated in the figure, two first viewpoint pixels PX_R1 and PX_B1 may be disposed in the first unit pixel area UA1, and the two first viewpoint pixels PX_R1 and PX_B1 may emit light having different primary colors.

In addition, the first viewpoint pixels may be appropriately disposed corresponding to tilt angles of the lenticular lenses so that light of the first viewpoint pixels propagate to the first viewpoint at an OVD through the lenticular lenses.

The lenticular lenses may be disposed on the pixels at a tilt angle VA2 of an extension direction of the lenticular lenses with respect to the column direction. The tilt angle VA2 of the lenticular lenses according to an exemplary embodiment may be calculated using Equation 1.

FIG. 7 illustrates an example of the lenticular lenses when n equals 4 and b equals 5. The tilt angle VA2 of the lenticular lenses illustrated in FIG. 7 is 32.0° when calculated based on Equation 1.

In this instance, a width LP of a lenticular lens may be determined based on Equation 2. A pitch of each of the lenticular lenses is 8 dots when calculated based on

Equation 2, and the 8 dots correspond to the horizontal pitch Hp of eight pixels. A width of one lens may correspond to one unit pixel area.

Six first viewpoint pixels may be disposed in three unit pixel areas UA1, UA2 and UA3 contiguous in a row direction. Among the six first viewpoint pixels, two first viewpoint pixels are red pixels (R), two first viewpoint pixels are green pixels (G), and two first viewpoint pixels are blue pixels (B). In other words, the six first viewpoint pixels disposed in a region corresponding to a width of three lenticular lenses may form two sets of RGB pixels.

The width of the three lenses correspond to the width of the three unit pixel areas UA1, UA2 and UA3, and the six first viewpoint pixels may form two sets of RGB pixels in the three unit pixel areas UA1, UA2 and UA3.

A maximum number of viewpoints displayable by a multi-view image display device according to other exemplary embodiments may be calculated using Equation 3. In the example of FIG. 7, n equals 4, and thus the maximum number of viewpoints displayable by the multi-view image display device is 16 when calculated based on Equation 3.

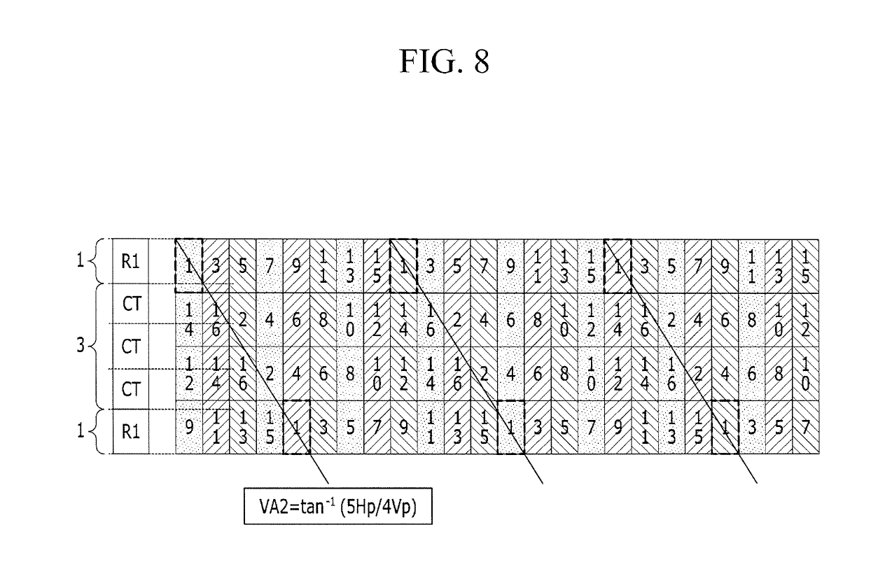

Next, referring to FIG. 8, a description will be given of crosstalk generated in a multi-view image display device according to other exemplary embodiments.

FIG. 8 schematically illustrate crosstalk of a multi-view image display device according to other exemplary embodiments.

Light of pixels that overlap the same tilt angle line illustrated in FIG. 8 may propagate to the same viewpoint at the OVD. The tilt angle line overlaps a first viewpoint pixel 1, a second viewpoint pixel 2 and a sixteenth viewpoint pixel 16. Thus, light emitted from the first viewpoint pixel 1, the second viewpoint pixel 2 and the sixteenth viewpoint pixel 16 may propagate to a first viewpoint at the OVD.

Therefore, when an observer is positioned at the first viewpoint of the OVD, light from the second viewpoint pixel 2 and the sixteenth viewpoint pixel 16 may be received in addition to light from the first viewpoint pixel 1, and thus crosstalk may be generated

When crosstalk is generated, an observer may view an abnormal image.

Referring to a ratio of generated crosstalk based on the tilt angle line in FIG. 8, when light emitted from the first viewpoint pixel 1 has a ratio of 2, light of the second viewpoint pixel 2 and the sixteenth viewpoint pixel 16 has a ratio of 3, and thus crosstalk is generated at a ratio of 150%.

Therefore, a ratio of generated crosstalk increases in a multi-view image display device of FIG. 7 when compared to a multi-view image display device of FIG. 4.

However, RGB pixels of a multi-view image display device of FIG. 7 which correspond to one viewpoint are disposed in a shape more similar to an equilateral triangle than when compared to a multi-view image display device of FIG. 4, and thus is more effective in enhancing a resolution of a displayed image.

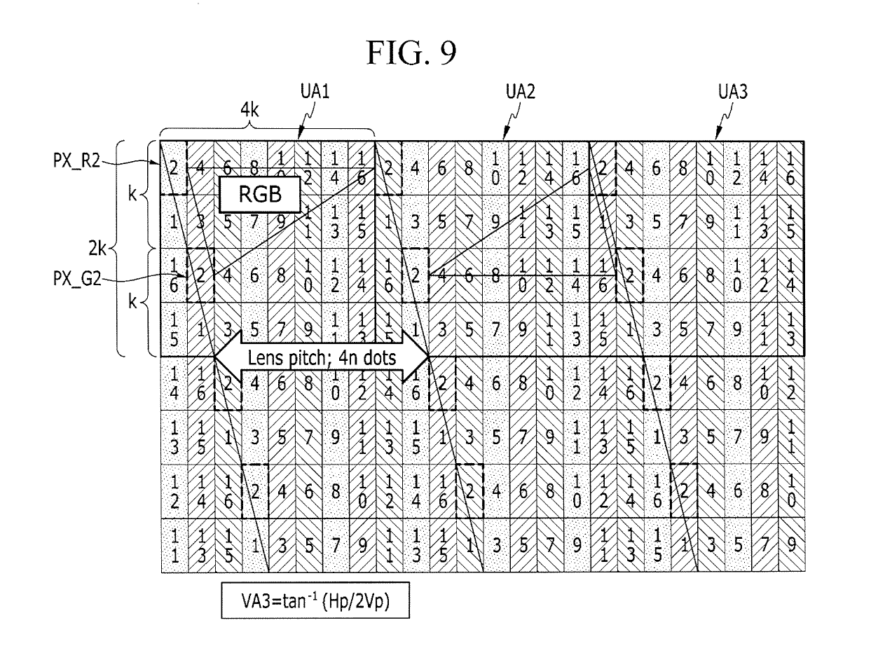

Next, a description will be given of a multi-view image display device according to other exemplary embodiments with reference to FIG. 9.

FIG. 9 illustrates an arrangement of lenticular lenses 800 and a display panel 300 of a multi-view image display device according to other embodiments. As illustrated in the figure, a plurality of pixels that emit light corresponding to a plurality of viewpoints may be disposed in each unit pixel areas UA1, UA2 and UA3 formed on a 2k×4k-dot basis.

For example, first viewpoint pixels that emit light corresponding to a first viewpoint, second viewpoint pixels that emit light corresponding to a second viewpoint, . . . , and sixteenth viewpoint pixels that emit light corresponding to a sixteenth viewpoint may be disposed in each of the unit pixel areas.

A plurality of viewpoint pixels that correspond to the first viewpoint pixels, the second viewpoint pixels, . . . , or the sixteenth viewpoint pixels may be disposed in each of the unit pixel areas. For example, the second viewpoint pixels disposed in the same unit pixel area may emit light having different primary colors. As illustrated in the figure, two second viewpoint pixels PX_R2 and PX_G2 are disposed in the first unit pixel area UA1, and the two second viewpoint pixels PX_R2 and PX_{—} G2 may emit light having different primary colors.

In addition, the second viewpoint pixels may be appropriately disposed corresponding to tilt angles of the lenticular lenses such that light of the second viewpoint pixels propagate to the second viewpoint at the OVD through the lenticular lenses.

The lenticular lenses may be disposed on the pixels at a tilt angle VA3 formed by the extension direction of the lenticular lenses with respect to the column direction. The tilt angle VA3 of the lenticular lenses according to other exemplary embodiments may be calculated using the following Equation 4.

$$VA = {tan}^{- 1} \frac{Hp}{k \times Vp} \qquad [ Equation 4 ]$$

Here, VA denotes the tilt angle of the extension direction of the lenticular lenses with respect to the column direction, Hp denotes a pixel pitch in a horizontal direction, and Vp denotes a pixel pitch in a vertical direction.

FIG. 9 illustrates an example of the lenticular lenses when k equals 2. The tilt angle VA3 of the lenticular lenses illustrated in FIG. 9 is 14.04° when calculated based on Equation 4.

In this instance a width LP (lens pitch) of a lenticular lens may be determined based on the following Equation 5.

LP=4k [Equation 5]

In this instance, a unit of LP may be dot. A pitch of each of the lenticular lenses illustrated in FIG. 9 is 8 dots when calculated based on Equation 5, and the 8 dots correspond to the horizontal pitch Hp of eight pixels. A width of one lens may correspond to one unit pixel area.

Six first viewpoint pixels may be disposed in three unit pixel areas UA1, UA2 and UA3 contiguous in a row direction. Among the six first viewpoint pixels, two first viewpoint pixels are red pixels (R), two first viewpoint pixels are green pixels (G), and two first viewpoint pixels are blue pixels (B). In other words, the six first viewpoint pixels disposed in a region corresponding to a width of three lenticular lenses may form two sets of RGB pixels.

The width of the three lenses correspond to a width of the three unit pixel areas UA1, UA2 and UA3, and the six second viewpoint pixels may form two sets of RGB pixels in the three unit pixel areas UA1, UA2 and UA3. Thus, a maximum number of viewpoints displayable by a multi-view image display device according to an exemplary embodiment may be calculated using the following Equation 6.

$$The Number of View Points = \frac{3 \times 2 k \times 4 k}{2 \times 3} = 4 {k}^{2} \qquad [ Equation 6 ]$$

where the “3” in the numerator refers to three unit pixel areas UA1, UA2, and UA3, 2k×4k is the area of one unit pixel area, and the “2” in the denominator refers to 2 sets of RGB (2×3) pixels, which equals to 4k².

In the example of FIG. 9, k equals 2, and thus the maximum number of viewpoints displayable by the multi-view image display device is 16 when calculated based on Equation 6.

A multi-view image display device may form two sets of RGB pixels corresponding to respective viewpoints in the unit pixel areas UA1, UA2 and UA3 corresponding to the width of the three lenses. In this instance, the RGB pixels may be disposed in a triangular shape, thereby enhancing a resolution of a displayed image.

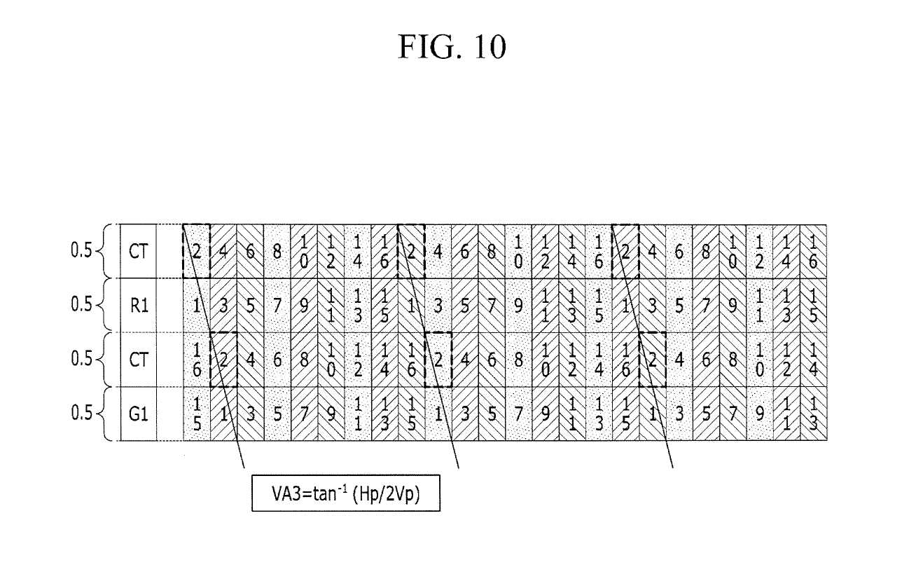

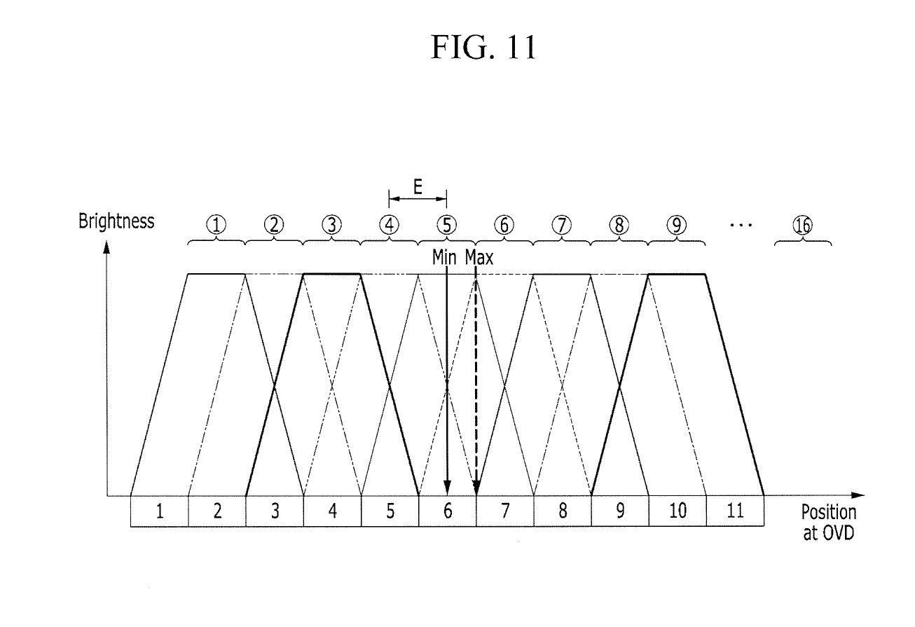

Next, a description will be given of crosstalk generated in a multi-view image display device according to an exemplary embodiment with reference to FIGS. 10 and 11.

FIG. 10 schematically illustrates crosstalk of a multi-view image display device according to other exemplary embodiments, and FIG. 11 is a graph of crosstalk observed at the OVD of a multi-view image display device according to another exemplary embodiments.

Light from pixels that overlap the same tilt angle line illustrated in FIG. 10 may propagate to the same viewpoint at the OVD. The tilt angle line overlaps a first viewpoint pixel 1 and a second viewpoint pixel 2. Thus, light emitted from the first viewpoint pixel 1 and the second viewpoint pixel 2 may propagate to a first viewpoint at the OVD.

Therefore, when an observer is positioned at the first viewpoint of the OVD, light of the second viewpoint pixel 2 may be received in addition to light of the first viewpoint pixel 1, and thus crosstalk may be generated. When crosstalk is generated, the observer may view an abnormal image.

Referring to a ratio of generated crosstalk based on the tilt angle line in FIG. 10, when light emitted from the first viewpoint pixel 1 has a ratio of 1, the light of the second viewpoint pixel 2 has a ratio of 1, and thus crosstalk is generated at a ratio of 100%.

Referring to FIG. 11 in this regard, light from pixels disposed on the display panel 300 pass through the lenticular lenses 800, and light may be received at positions \textcircled{1} to \textcircled{16} respectively corresponding to the first to sixteenth viewpoints of the OVD. In this instance, it may be assumed that a width at each of the positions corresponds to a distance E between two eyes of the observer.

Referring to position \textcircled{5} corresponding to a fifth viewpoint, when maximum crosstalk (Max) is generated, a ratio of light of a fifth viewpoint pixel 5 is 1, and a ratio of light of a sixth viewpoint pixel 6 is 1, and thus crosstalk may be generated at a ratio of 1/1=100%

On the other hand, when minimum crosstalk (Min) is generated, the ratio of light of the fifth viewpoint pixel 5 is 1, the ratio of light of the sixth viewpoint pixel 6 is 0.5, and a ratio of light of a seventh viewpoint pixel 7 is 0.5, and thus crosstalk may be generated at a ratio of 1/1=100%.

As described with reference to FIGS. 10 and 11, a multi-view image display device according to another exemplary embodiments can be effective in suppressing crosstalk since crosstalk is generated at a ratio of 100%.

The above-described present disclosure may be embodied as computer-readable code on a non-transitory medium having a program recorded thereon. The computer-readable medium may be any type of recording device in which data is stored in a computer system-readable manner. Examples of the computer-readable medium include a hard disk drive (HDD), a solid state disk (SSD), a silicon disk drive (SDD), a read only memory (ROM), a random access memory (RAM), a CD-ROM, a magnetic tape, a floppy disc, an optical data storage device, etc. In addition, the computer may include a controller of a terminal. Thus, the above detailed description should be considered to be illustrative rather than restrictive in all aspects. The scope of embodiments of the present disclosure should be determined by a reasonable interpretation of the accompanying claims, and all changes within an equivalent range of the present disclosure are included in the scope of the present disclosure.

While embodiments of this disclosure have been described in connection with what is presently considered to be practical exemplary embodiments, it is to be understood that exemplary embodiments of the disclosure are not limited to the disclosed embodiments, but, on the contrary, are intended to cover various modifications and equivalent arrangements included within the spirit and scope of the appended claims.

What is claimed is:

1. A multi-view image display device comprising:
a display panel that includes a plurality of pixels arranged in a matrix form; and
a viewpoint divider configured to divide an image received from the display panel into images that correspond to k viewpoints,
wherein the viewpoint divider includes a plurality of viewpoint division units that are tilted with respect to a column direction of the pixels at a tilt angle VA that satisfies the following equation:
$$VA = {tan}^{- 1} \frac{b \times Hp}{n \times Vp} , \\ n \neq b , \\ b \neq 1 ,$$
wherein Hp denotes a pixel pitch in a row direction of the pixels, Vp denotes a pixel pitch in the column direction, b and n are natural numbers and b/n corresponds to an irreducible fraction,
wherein a plurality of first pixels that emit light that propagates through a same viewpoint division unit to substantially a same position at a predetermined distance from the viewpoint divider are arranged in a unit pixel area defined on an n×2n-dot basis of the display panel.

2. The multi-view image display device of claim 1, wherein:
the plurality of first pixels included in the unit pixel area display different primary colors.

3. The multi-view image display device of claim 2, wherein:
a plurality of first pixels included in unit pixel areas corresponding to three viewpoint division units include two sets of red (R) pixels, green (G) pixels and blue (B) pixels.

4. The multi-view image display device of claim 3, wherein:
a pitch of each viewpoint division unit corresponds to 2n pixels.

5. The multi-view image display device of claim 4, wherein:
a plurality of pixels included in three unit pixel areas include R pixels, G pixels and B pixels corresponding to n² viewpoints.

6. The multi-view image display device of claim 1, wherein:
n equals 4, and b equals 3.

7. The multi-view image display device of claim 1, wherein:
n equals 4, and b equals 5.

8. The multi-view image display device of claim 1, wherein:
the viewpoint division units include lenticular lenses.

9. The multi-view image display device of claim 1, wherein:
pixels in adjacent pixel columns display different primary colors.

10. A multi-view image display device comprising:
a display panel that includes a plurality of pixels arranged in a matrix form; and
a viewpoint divider configured to divide an image received the display panel into images corresponding to k viewpoints,
wherein the viewpoint divider includes a plurality of viewpoint division units that are tilted with respect to a column direction of the pixels at a tilt angle VA that satisfies the following equation:
$$VA = {tan}^{- 1} \frac{Hp}{k \times Vp} ,$$
wherein Hp denotes a pixel pitch in a row direction of the pixels, Vp denotes a pixel pitch in the column direction, and k is a natural number,
wherein a plurality of first pixels that emit light that propagates through a same viewpoint division unit to substantially a same position at a predetermined distance from the viewpoint divider are arranged in a unit pixel area defined on a 2k×k-dot basis of the display panel.

11. The multi-view image display device of claim 10, wherein:
the plurality of first pixels included in the unit pixel area display different primary colors.

12. The multi-view image display device of claim 11, wherein:
a plurality of first pixels included in unit pixel areas corresponding to three viewpoint division units include two sets of red (R) pixels, green (G) pixels and blue (B) pixels.

13. The multi-view image display device of claim 12, wherein:
a pitch of each viewpoint division unit corresponds to 4k pixels.

14. The multi-view image display device of claim 13, wherein:
a plurality of pixels included in three unit pixel areas include R pixels, G pixels and B pixels corresponding to 4k² viewpoints.

15. A multi-view image display device comprising:
a display panel that includes a plurality of pixels arranged in a matrix form; and
a viewpoint divider configured to divide an image received from the display panel into images that correspond to k viewpoints,
wherein the viewpoint divider includes a plurality of viewpoint division units that are tilted with respect to a column direction of the pixels at a tilt angle VA,
a plurality of first pixels that emit light that propagates through a same viewpoint division unit to substantially a same position at a predetermined distance from the viewpoint divider are arranged in a unit pixel area defined on the display panel,
the plurality of first pixels included in the unit pixel area display different primary colors, and
a plurality of first pixels included in unit pixel areas corresponding to three viewpoint division units include two sets of red (R) pixels, green (G) pixels and blue (B) pixels.

16. The multi-view image display device of claim 15, wherein
the unit pixel area is defined on an n×2n-dot basis the display panel, and
the tilt angle VA satisfies the following equation:
$$VA = {tan}^{- 1} \frac{b \times Hp}{n \times Vp} , \\ n \neq b , \\ b \neq 1 ,$$
wherein Hp denotes a pixel pitch in a row direction of the pixels, Vp denotes a pixel pitch in the column direction, b and n are natural numbers and b/n corresponds to an irreducible fraction.

17. The multi-view image display device of claim 16, wherein
a pitch of each viewpoint division unit corresponds to 2n pixels, and
a plurality of pixels included in three unit pixel areas include R pixels, G pixels and B pixels corresponding to n² viewpoints.

18. The multi-view image display device of claim 15, wherein
the unit pixel area is defined on an 2k×k-dot basis the display panel, and
the tilt angle VA satisfies the following equation:
$$VA = {tan}^{- 1} \frac{Hp}{k \times Vp} ,$$
wherein Hp denotes a pixel pitch in a row direction of the pixels, Vp denotes a pixel pitch in the column direction, and k is a natural number.

19. The multi-view image display device of claim 18, wherein
a pitch of each viewpoint division unit corresponds to 4k pixels, and
a plurality of pixels included in three unit pixel areas include R pixels, G pixels and B pixels corresponding to 4k² viewpoints.

20. The multi-view image display device of claim 15, wherein
the viewpoint division units include lenticular lenses.
